(19) United States
(12) Patent Application Publication
(10) Pub. No.: US 2007/0068915 A1
(43) Pub. Date: Mar. 29, 2007

(54) Thermostatic biasing controller, method of thermostatic biasing and an integrated circuit employing the same

(75) Inventors: Theodore W. Houston, Richardson, TX (US); Andrew Marshall, Dallas, TX (US)

Correspondence Address: TEXAS INSTRUMENTS INCORPORATED, P O BOX 655474, M/S 3999, DALLAS, TX, 75265, US

(73) Assignee: Texas Instruments Inc., Dallas, TX (US)

(21) Appl. No.: 11/234,910

(22) Filed: Sep. 26, 2005

(51) Int. Cl. H05B 3/00; H05B 1/00; H05B 11/00

(52) U.S. Cl. 219/209

(57) ABSTRACT

The present invention provides a thermostatic biasing controller for use with an integrated circuit. In one embodiment, the thermostatic biasing controller includes a temperature sensing unit configured to determine an operating temperature of the integrated circuit. Additionally, the thermostatic biasing controller also includes a voltage controlling unit coupled to the temperature sensing unit and configured to provide a back-bias voltage corresponding to the operating temperature based on reducing a quiescent current of the integrated circuit.

### TECHNICAL FIELD OF THE INVENTION

The present invention is directed, in general, to microelectronics and, more specifically, to a thermostatic biasing controller, a method of thermostatic biasing and an integrated circuit employing the controller or the method.

### BACKGROUND OF THE INVENTION

Reverse back bias, that is, increasing the reverse bias between an integrated circuit body and the sources of transistors employed in the integrated circuit, has been a tool for reducing quiescent currents such as the direct drain quiescent current I_{DDQ}. A reverse back bias increases the threshold voltage Vₜ, thus reducing sub-threshold currents for the integrated circuit transistors. However, reverse back bias also increases the diode leakage between the integrated circuit body and the transistors. So, there is a trade-off between reducing sub-threshold current and increasing diode leakage.

The number of integrated circuit devices associated with an integrated circuit chip continues to increase while device size continues to scale downward thereby providing an increase in device density. These scaled technologies employ higher doping levels causing proportionally higher diode leakage. This increasing diode leakage thereby reduces the effectiveness of applying back bias to reduce I_{DDQ}. In fact, for some applications, applying back bias increases I_{DDQ} at room temperature.

Accordingly, what is needed in the art is a more effective way to compensate for these leakage effects, especially over a variety of operating temperature.

### SUMMARY OF THE INVENTION

To address the above-discussed deficiencies of the prior art, the present invention provides a thermostatic biasing controller for use with an integrated circuit. In one embodiment, the thermostatic biasing controller includes a temperature sensing unit configured to determine an operating temperature of the integrated circuit. Additionally, the thermostatic biasing controller also includes a voltage controlling unit coupled to the temperature sensing unit and configured to provide a back-bias voltage corresponding to the operating temperature based on reducing a quiescent current of the integrated circuit.

In another aspect, the present invention provides a method of thermostatic biasing for use with an integrated circuit. The method includes determining an operating temperature of the integrated circuit and providing a back-bias voltage corresponding to the operating temperature based on reducing a quiescent current of the integrated circuit. Additionally, the present invention also provides an alternative method of controlling a current for use with circuitry having a body region and employing a plurality of voltage outputs that varies with temperature. The alternative method includes generating a temperature-dependent hysteretic voltage by comparing the plurality of voltage outputs to a substantially invariant voltage and stabilizing the current with temperature by employing the temperature-dependent hysteretic voltage in body-biasing the body region.

The present invention also provides, in yet another aspect, an integrated circuit that includes a supply voltage, an integrated sub-circuit coupled to the supply voltage that has a body node connection and a thermostatic biasing controller coupled to the body node connection. The thermostatic biasing controller includes a temperature sensing unit that determines an operating temperature of the integrated circuit. The thermostatic biasing controller also includes a voltage controlling unit, coupled to the temperature sensing unit, that provides a back-bias voltage corresponding to the operating temperature based on reducing a quiescent current of the integrated circuit.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a diagram of an embodiment of an integrated circuit constructed in accordance with the principles of the present invention;

FIG. 2 illustrates a leakage graph showing an example of a leakage current hysteresis constructed in accordance with the principles of the present invention;

FIG. 3 illustrates a voltage graph showing an example of a body voltage hysteresis corresponding to the leakage current hysteresis of FIG. 2;

FIG. 4 illustrates a schematic diagram of an embodiment of a body-bias voltage circuit constructed in accordance with the principles of the present invention;

FIG. 5 illustrates a flow diagram of a method of thermostatic biasing carried out in accordance with the principles of the present invention; and

FIG. 6 illustrates a flow diagram of an embodiment of a method of controlling a current carried out in accordance with the principles of the present invention.

### DETAILED DESCRIPTION

Referring initially to FIG. 1, illustrated is a diagram of an embodiment of an integrated circuit, generally designated 100, constructed in accordance with the principles of the present invention. The integrated circuit 100 includes a header circuit 105, an integrated sub-circuit 110 and a thermostatic biasing controller 120. The integrated circuit 100 also includes an input/output supply voltage 106 and a supply voltage 107 coupled to the header circuit 105, which is employed to provide a virtual supply voltage 108 to the integrated sub-circuit 110. In the illustrated embodiment, the integrated sub-circuit 110 provides a temperature sensing connection 111 and a body node connection 112 from the integrated sub-circuit 110 to the thermostatic biasing controller 120.

The thermostatic biasing controller 120 includes a temperature sensing unit 121 coupled to the temperature sense connection 111 and a voltage control unit 122 coupled to the body node connection 112. In alternative embodiments, the thermostatic biasing controller 120 may be separate from the integrated circuit 100 or the integrated sub-circuit 110 while employing these connections. Additionally, the temperature sensing and body node connections 111, 112 may be integral with the thermostatic biasing controller 120, in yet other embodiments.

The temperature sensing unit 121 determines an operating temperature of the integrated sub-circuit 110, and the voltage controlling unit 122, which is coupled to the temperature sensing unit 121, provides a back-bias voltage 113 corresponding to the operating temperature based on reducing the quiescent current I_{DDQ} of the integrated sub-circuit 110. Of course, other embodiments may focus on reducing other quiescent currents as appropriate to a particular application.

In the illustrated embodiment, the integrated sub-circuit 110 is a SRAM having active and data-retention modes. In alternate embodiments, the integrated sub-circuit 110 may be a DSP or any of an assortment of general logic wherein the logic timing has been designed to function properly while employing a changing back-bias voltage. As noted earlier, applying a back-bias voltage may increase the quiescent current I_{DDQ} at room temperature. However, at a higher temperature (which is generally worst case for the quiescent current I_{DDQ}) the back-bias voltage will reduce the quiescent current I_{DDQ}. This temperature dependence results from the stronger temperature dependence of sub-threshold leakage versus the temperature dependence of diode leakage. Therefore, the thermostatic biasing controller 120 provides a temperature dependent back-bias voltage.

In the illustrated embodiment, the integrated sub-circuit 110 employs a temperature sensor that is located integral or “on-chip” with the integrated circuit 100. In an alterative embodiment, a temperature sensor may be located proximate the integrated sub-circuit 110. Either the on-chip or proximate temperature detector may be employed to control the connection of back-bias voltage, switching to reverse back bias for higher temperatures and to zero back bias (or even forward back bias) for lower temperatures. In addition, the temperatures of switching can be adjusted at test depending on the process corner. Also, a so-called “cold or weak” chip may not need to switch between modes until much higher temperatures. In some cases, switching may not be needed at all. This can be assessed at final test of the integrated sub-circuit 110, and fuses or other non-volatile memory may be employed to trim the temperatures of back-bias voltage switching appropriately.

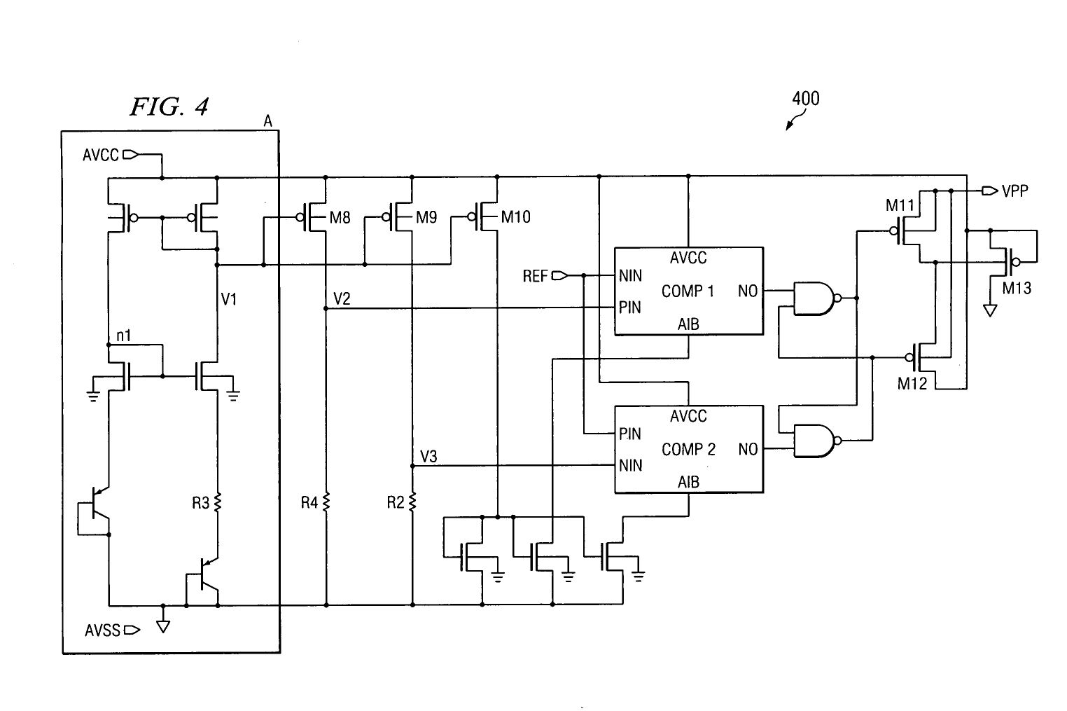

The temperature sensing unit 121 may determine the operating temperature on an intermittent basis. This normally corresponds to a low-power operating mode of the integrated sub-circuit 110. Additionally, the thermostatic biasing controller 120 may discontinue sampling the temperature of the integrated sub-circuit 110 upon reaching a predetermined temperature. For a low power mode, the power required for temperature sensing may be significant since temperature sensors can dissipate a fair amount of power. For such a case, the temperature sensing circuitry may be turned on periodically rather than continually. Also, periodic, sensing may be turned off, in the low power mode, once low temperature is detected. An example of such circuitry is discussed with respect to FIG. 4.

The voltage controlling unit 122 typically provides the back-bias voltage 113 that has a substantially constant value over a range of operating temperatures. Additionally, a plurality of back-bias voltages may be provided that correspond to a plurality of operating temperature ranges. In the illustrated embodiment, the back-bias voltage 113 may employ the input/output supply voltage 106, the supply voltage 107 or the virtual supply voltage 108. Alternatively, the back-bias voltage 113 provided by the voltage controlling unit 122 may vary continuously with temperature as appropriate to a particular application.

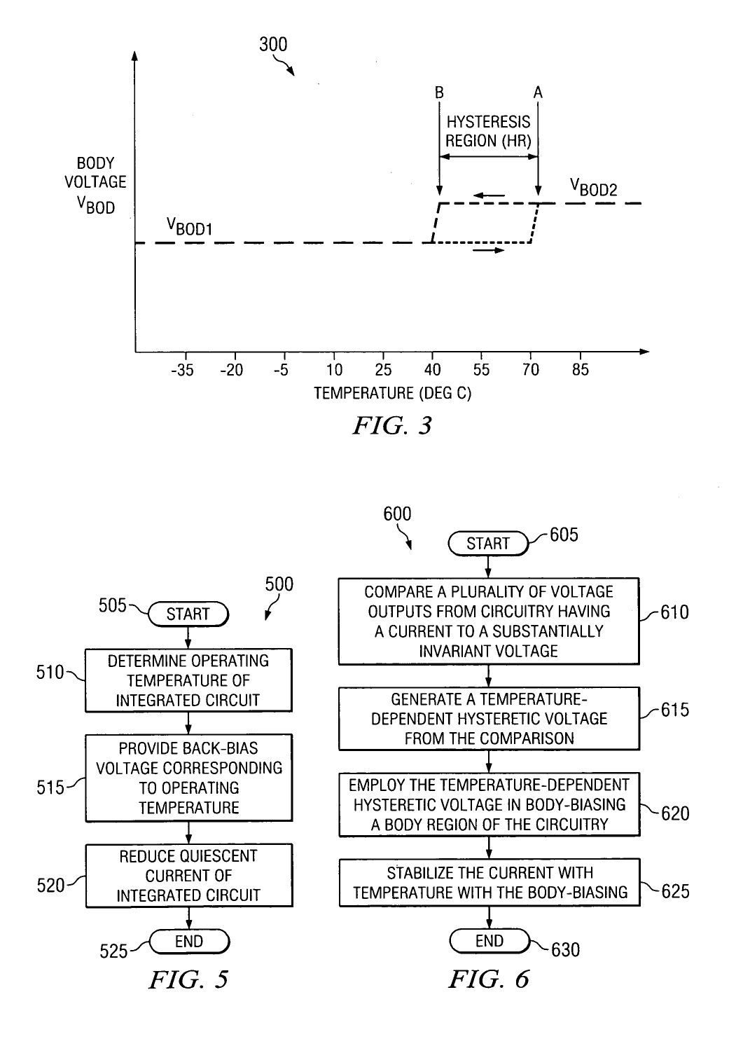

In the illustrated embodiment, the voltage controlling unit 122 provides the back-bias voltage 113 that exhibits a hysteresis as a function of temperature. The hysteresis allows a dynamic setting of the back-bias voltage 113 that prevents switching back and forth (i.e., dithering) between two values at a crossover point between two leakage currents or temperature regions. This characteristic is further illustrated and discussed with respect to FIGS. 3 and 4.

The thermostatic controller 120 may further employ a programation unit 123 having a fuse circuit to select the back-bias voltage 113. The fuse circuit provides a non-dynamic capability to select a reverse back-bias voltage. This allows the reverse back-bias voltage to be enabled for applications where high temperature is expected to dominate power concerns. Conversely, the reverse back-bias voltage may be disabled for applications where low temperature is expected to dominate power concerns. The fuse circuit may also be used to set the temperature-to-body relationship. For example, a fuse circuit may be used to set the temperature at which the body bias is switched from one value to another.

The fuse circuit is typically a one-time and non-dynamic option that is set at packaging, when knowing the application intended for the integrated sub-circuit 110 or when knowing the transistor characteristics of the circuit. Additionally, the fuse circuit may be used in conjunction with or be replaced by a ROM setting associated with a ROM circuit, also included in the programation unit 123, and be field programmable.

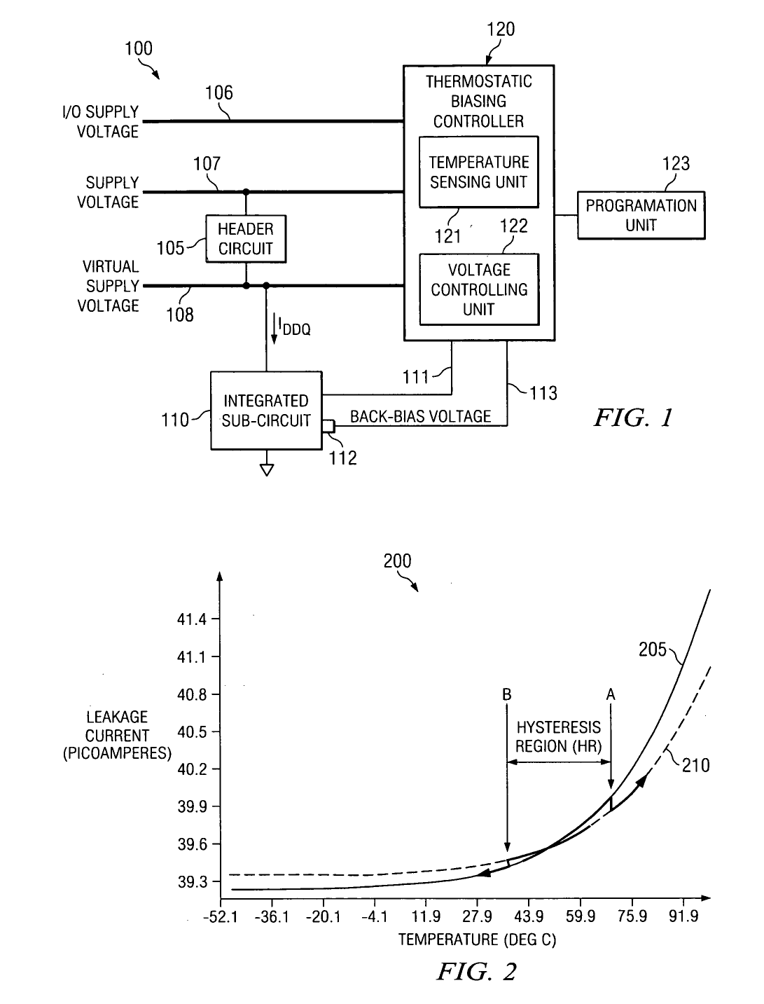

Turning now to FIG. 2, illustrated is a leakage graph showing an example of a leakage current hysteresis, generally designated 200, constructed in accordance with the principles of the present invention. The leakage graph 200 includes first and second leakage current curves 205, 210 and a hysteresis region HR, which occurs between a first hysteresis point A and a second hysteresis point B, as shown. The first hysteresis point A provides a shift from the first leakage current curve 205 to the second leakage current curve 210, which may be seen to provide lower values of leakage current with increasing temperatures. A corresponding effect occurs at the second hysteresis point B where a shift from the second leakage current curve 210 to the first leakage current curve 205, which may be seen to provide lower values of leakage current with decreasing temperatures. Employing the hysteresis region HR avoids a dithering between the first and second leakage current curves 205, 210 at their cross-over point, which may otherwise occur.

Turning now to FIG. 3, illustrated is a voltage graph showing an example of a body voltage hysteresis, generally designated 300, corresponding to the leakage current hysteresis of FIG. 2. The voltage graph 300 includes first and second body voltage levels V_{BOD1}, V_{BOD2} and a hysteresis region HR, which occurs between a first hysteresis point A and a second hysteresis point B, as shown. The first and second body voltage levels V_{BOD1}, V_{BOD2} indicate how a body node associated with an integrated circuit, such as that discussed with respect to FIG. 1, may be varied to modify the leakage current of the integrated circuit as was discussed with respect to FIG. 2.

Turning now to FIG. 4, illustrated is a schematic diagram of an embodiment of a body-bias voltage circuit, generally designated 400, constructed in accordance with the principles of the present invention. The body-bias voltage circuit 400 is an exemplary schematic showing how the switching between body biases, including hysteresis, may be achieved. A dual temperature sensor is used to trigger the switch between modes. As temperature rises, this switch occurs at a higher temperature. As the temperature cools, switching back to the original state does not occur until the lower temperature is reached. This temperature level can also be used as part of an “OR” function to switch-off the temperature sensor (i.e., while the power or the temperature is high, the temperature sensor is ON). This may be modified for further power reduction by only enabling the temperature sensor periodically, either continually or just when the standby mode has been initiated.

Sub-circuit A of FIG. 4 shows a conventional MOS-based Iptat. This generates a current which can be mirrored through M8, M9 and M10, to provide either a temperature dependent or temperature independent current that is largely independent of other factors, especially supply voltage. Resistors R4 and R2 are of the same material type as resistor R3, but are of different values, which negate the variability of the resistor type. The resulting voltages V2 and V3 are dependent on the Iptat current generator and values of resistors R2 and R4. They can be adjusted by modifying the Iptat components, the ratio of M8:M9:M10 and the values of resistors R2 and R4. These voltages define the trigger points of the body bias switches. Currents supplied to the AIB inputs of first and second comparator modules COMP1, COMP2 are herein generated by the Iptat, but alternatively, may also be generated by any other current source method. The reference can be generated by any convenient reference supply, or could readily be generated from the Iptat.

The voltages V2 and V3 rise and fall with temperature. As temperature rises and the threshold of the voltage V2 rises above a reference voltage Vref, the first comparator module COMP1 switches from LOW to HIGH, but does not affect the state of M11 and M12. When the voltage V3 becomes higher than the reference voltage Vref, at some higher temperature, the second comparator module COMP2 switches, forcing M12 gate LOW and M11 gate HIGH, thereby switching the body bias of M13 into the lower leakage “body bias to source” state. If the temperature decreases, nothing happens to the state of M11 and M12 until the voltage V2 is below the reference voltage Vref, wherein M11 turns ON and M12 turns OFF, changing the gate biasing. The hysteresis thus afforded prevents an indeterminate state around the body switching point.

Turning now to FIG. 5, illustrated is a flow diagram of an embodiment of a method of thermostatic biasing, generally designated 500, carried out in accordance with the principles of the present invention. The method 500 is for use with and an integrated circuit and starts in a step 505. Then, in a step 510, an operating temperature of the integrated circuit is determined. Determination of the operating temperature may employ a temperature sensor located proximate the integrated circuit or a temperature sensor that is integral with the integrated circuit.

Additionally, the operating temperature may be determined on a continuous basis or it may be determined on an intermittent basis wherein it is sampled either periodically or randomly over time. Since temperature sampling requires a power expenditure, a low-power operating mode of the integrated circuit may typically employ an intermittent sampling of the operating temperature. Also, this intermittent sampling may also be discontinued when the integrated circuit has reached a predetermined temperature or crossed a temperature threshold thereby allowing additional power conservation.

A back-bias voltage corresponding to the operating temperature is provided in a step 515. The back-bias voltage is applied to a body node of the integrated circuit. A same back-bias voltage may be employed over a range of operating temperatures. This would also allow the back-bias voltage to be supplied as a difference between two voltages for a band of operating temperatures. The back-bias voltage may employ a supply voltage or a virtual supply voltage derived from the supply voltage. Also, the back-bias voltage may employ an input/output supply voltage, as well.

Additionally, a plurality of back-bias voltages may be employed corresponding to a plurality of operating temperature ranges or bands. This plurality of back-bias voltages may be structured in values to provide a tailored leakage or quiescent current response for the integrated circuit.

The back-bias voltage may be programmable in either discrete steps or in a continuous manner. In order to avoid a dithering of the back-bias voltage between two values at a control cross-over point, hysteresis as a function of temperature may be employed. Additionally, if the operating temperature of the integrated circuit is set or determined to be a particular value, a fuse circuit or a ROM (read-only memory) circuit may select an appropriate back-bias voltage.

Then, in a step 520, a quiescent current of the integrated circuit is reduced employing the back-bias voltage provided in the step 515. The quiescent current is typically a direct drain quiescent current (I_{DDQ}) associated with the integrated circuit. However, the principles of the present invention may be employed to reduce other leakage or quiescent currents of the integrated circuit as may be appropriate to a particular application. The method 500 ends in a step 525.

Turning now to FIG. 6, illustrated is a flow diagram of an embodiment of a method of controlling a current, generally designated 600, carried out in accordance with the principles of the present invention. The method 600 is used with circuitry having a body region, employing a plurality of voltage outputs that varies with temperature and starts in a step 605.

Then in a step 610, the plurality of voltage outputs is compared to a substantially invariant voltage, and a temperature-dependent hysteretic voltage is generated from the comparison in a step 615. The temperature-dependent hysteretic voltage is employed in body-biasing a body region of the circuitry in a step 620. Application of the temperature-dependent hysteretic voltage in the step 620 provides body-biasing that results in stabilizing the current with respect to temperature for the circuitry. The method ends in a step 625.

While the methods disclosed herein have been described and shown with reference to particular steps performed in a particular order, it will be understood that these steps may be combined, subdivided, or reordered to form equivalent methods without departing from the teachings of the present invention. Accordingly, unless specifically indicated herein, the order or the grouping of the steps is not a limitation of the present invention.

In summary, embodiments of the present invention employing a thermostatic biasing controller, a method of thermostatic biasing and an integrated circuit employing the controller or the method have been presented. An additional embodiment of a method of controlling a current associated with circuitry has also been presented. Advantages include the ability to select or adapt a back-bias voltage as a function of operating temperature that will reduce a quiescent current for an integrated circuit as appropriate to a particular application. The additional method of controlling the current provides a temperature-dependent hysteretic voltage that is employed in body-biasing a body region of the circuitry thereby providing stabilization of the current with temperature. Embodiments of the present invention allow reductions in operating power for integrated circuits, which is becoming an attribute of primary concern.

Although the present invention has been described in detail, those skilled in the art should understand that they can make various changes, substitutions and alterations herein without departing from the spirit and scope of the invention in its broadest form.

What is claimed is:

1. A thermostatic biasing controller for use with an integrated circuit, comprising:
a temperature sensing unit configured to determine an operating temperature of said integrated circuit; and
a voltage controlling unit coupled to said temperature sensing unit and configured to provide a back-bias voltage corresponding to said operating temperature based on reducing a quiescent current of said integrated circuit.

2. The controller as recited in claim 1 wherein said operating temperature is determined by one selected from the group consisting of:
a temperature sensor proximate said integrated circuit; and
a temperature sensor integral with said integrated circuit.

3. The controller as recited in claim 1 wherein said operating temperature is determined on an intermittent basis.

4. The controller as recited in claim 3 wherein determining said operating temperature on said intermittent basis corresponds to a low-power operating mode of said integrated circuit.

5. The controller as recited in claim 3 wherein determining said operating temperature on said intermittent basis is discontinued upon reaching a predetermined temperature.

6. The controller as recited in claim 1 wherein a same back-bias voltage is employed over a range of operating temperatures.

7. The controller as recited in claim 1 wherein a plurality of back-bias voltages are employed corresponding to a plurality of operating temperature ranges.

8. The controller as recited in claim 1 wherein said back-bias voltage is programmable.

9. The controller as recited in claim 1 wherein said back-bias voltage is selected by one from the group consisting of:
a fuse circuit; and
a ROM circuit.

10. The controller as recited in claim 1 wherein said back-bias voltage exhibits a hysteresis as a function of temperature.

11. The controller as recited in claim 1 wherein said back-bias voltage employs at least one selected from the group consisting of:
a supply voltage;
an input/output supply voltage; and
a virtual supply voltage.

12. The controller as recited in claim 1 wherein providing said back-bias voltage employs a body node of said integrated circuit.

13. The controller as recited in claim 1 wherein said quiescent current is a direct drain quiescent current (I_{DDQ}).

14. A method of thermostatic biasing for use with an integrated circuit, comprising:
determining an operating temperature of said integrated circuit; and
providing a back-bias voltage corresponding to said operating temperature based on reducing a quiescent current of said integrated circuit.

15. The method as recited in claim 14 wherein said operating temperature is determined by one selected from the group consisting of:
a temperature sensor proximate said integrated circuit; and
a temperature sensor integral with said integrated circuit.

16. The method as recited in claim 14 wherein said operating temperature is determined on an intermittent basis.

17. The method as recited in claim 16 wherein determining said operating temperature on said intermittent basis corresponds to a low-power operating mode of said integrated circuit.

18. The method as recited in claim 16 wherein determining said operating temperature on said intermittent basis is discontinued upon reaching a predetermined temperature.

19. The method as recited in claim 14 wherein a same back-bias voltage is employed over a range of operating temperatures.

20. The method as recited in claim 14 wherein a plurality of back-bias voltages are employed corresponding to a plurality of operating temperature ranges.

21. The method as recited in claim 14 wherein said back-bias voltage is programmable.

22. The method as recited in claim 14 wherein said back-bias voltage is selected by one from the group consisting of:
a fuse circuit; and
a ROM circuit.

23. The method as recited in claim 14 wherein said back-bias voltage exhibits a hysteresis as a function of temperature.

24. The method as recited in claim 14 wherein said back-bias voltage employs at least one selected from the group consisting of:
a supply voltage;
an input/output supply voltage; and
a virtual supply voltage.

25. The method as recited in claim 14 wherein providing said back-bias voltage employs a body node of said integrated circuit.

26. The method as recited in claim 14 wherein said quiescent current is a direct drain quiescent current (I_{DDQ}).

27. An integrated circuit, comprising:
a supply voltage;
an integrated sub-circuit coupled to said supply voltage and having a body node connection; and
a thermostatic biasing controller coupled to said body node connection, including:
a temperature sensing unit that determines an operating temperature of said integrated circuit, and
a voltage controlling unit, coupled to said temperature sensing unit, that provides a back-bias voltage corresponding to said operating temperature based on reducing a quiescent current of said integrated circuit.

28. The integrated circuit as recited in claim 27 wherein said operating temperature is determined by one selected from the group consisting of:
a temperature sensor proximate said integrated circuit; and
a temperature sensor integral with said integrated circuit.

29. The integrated circuit as recited in claim 27 wherein said operating temperature is determined on an intermittent basis.

30. The integrated circuit as recited in claim 29 wherein determining said operating temperature on said intermittent basis corresponds to a low-power operating mode of said integrated circuit.

31. The integrated circuit as recited in claim 29 wherein determining said operating temperature on said intermittent basis is discontinued upon reaching a predetermined temperature.

32. The integrated circuit as recited in claim 27 wherein a same back-bias voltage is employed over a range of operating temperatures.

33. The integrated circuit as recited in claim 27 wherein a plurality of back-bias voltages are employed corresponding to a plurality of operating temperature ranges.

34. The integrated circuit as recited in claim 27 wherein said back-bias voltage is programmable.

35. The integrated circuit as recited in claim 27 wherein said back-bias voltage is selected by one from the group consisting of:
a fuse circuit; and
a ROM circuit.

36. The integrated circuit as recited in claim 27 wherein said back-bias voltage exhibits a hysteresis as a function of temperature.

37. The integrated circuit as recited in claim 27 wherein said back-bias voltage employs at least one selected from the group consisting of:
an input/output supply voltage; and
a virtual supply voltage.

38. The integrated circuit as recited in claim 27 wherein said quiescent current is a direct drain quiescent current (I_{DDQ}).

39. A method of controlling a current for use with circuitry having a body region and employing a plurality of voltage outputs that varies with temperature, comprising:
generating a temperature-dependent hysteretic voltage by comparing said plurality of voltage outputs to a substantially invariant voltage; and
stabilizing said current with temperature by employing said temperature-dependent hysteretic voltage in body-biasing said body region.
